(19) United States
(12) Patent Application Publication
(10) Pub. No.: US 2024/0302192 A1
(43) Pub. Date: Sep. 12, 2024

(54) Amplified Pitot Flow Meter

(71) Applicant: Gerald Andrew Fioriti, Rock Tavern, NY (US)

(72) Inventor: Gerald Andrew Fioriti, Rock Tavern, NY (US)

(21) Appl. No.: 18/600,683

(22) Filed: Mar. 9, 2024

Related U.S. Application Data
(60) Provisional application No. 63/489,769, filed on Mar. 12, 2023.

(51) Int. Cl. G01F 1/46; G01F 1/50

(52) U.S. Cl. CPC G01F 1/46; G01F 1/50

(57) ABSTRACT

This invention is a monitoring device to measure, display, and transmit the flow rate, pressure, and temperature of fluid passing through a conduit. The device uniquely measures amplified pressure signals at two points downstream of a constriction, and the temperature of the fluid, then calculates the flow rate and pressure with corrections for pressure and temperature and specific gravity of the fluid. The device may have a sliding laminar-flow guide-element with an integral pulsation damper to extend the measurement range. The flow rate is proportional to the difference between the magnified total-pressure and the diminished static-pressure. User interface includes an LCD display of the flow, pressure, and temperature, and five-minute averages for the same parameters, and a totalizing function for a user defined time period. All parameters are recorded on an SD card and transmitted via WIFI to a pc or smartphone and to a cloud dashboard.

### CROSS REFERENCE TO RELATED APPLICATIONS

This application claims priority to U.S. Provisional Application Ser. No. 63/489,769 titled “Optimized Pitot Flow Meter”, filed on Mar. 17, 2023, by same inventor Gerald A. Fioriti.

### DETAILED DESCRIPTION

The present invention provides a method and device for determining the flow rate of a fluid based on measured values of fluid pressure at two distinct and unique points within a conduit, having a USPTO classification 73/861.65 and 0.42 (Measuring & Testing/Volume or Rate of Flow/Pitot and Differential Pressure). Currently available differential pressure meters position one sensor upstream and a second sensor downstream of a flow constriction. Placing the sensor in a location upstream of the constriction exposes the sensor to incoming flow disturbances and a pressure reading that is not amplified.

This invention uses a contraction of the conduit to create a consistent flow profile regardless of upstream flow disturbances. The first sensor is slightly downstream of the constriction and opposing the flow at the vena-contracta of the fluid stream; thereby measuring an amplified stagnation-point pressure. The second sensor measures a diminished static-pressure at a configured high velocity point downstream of the first sensor; thereby creating a magnified differential pressure signal at all flow rates, extending the operating range of the meter, and making the meter less sensitive to incoming flow disturbances or pipe elbow locations. The differential pressure is correlated to fluid flow by a digital processing unit with access to tables stored in non-volatile memory. A temperature sensor input to a digital processing unit is used to calculate the fluid density correction for liquids and gases using standard engineering equations. The flow rate is corrected for temperature and pressure prior to display and logging.

This invention is based on simulation, observation, logic, and extensive testing of the physical geometry of a flow conduit shape, and the optimal positioning of the sensors within that conduit. Some guidance was taken from nature in that both the overall dimensional ratio of flow conduit length to constriction location, and the full flow conduit diameter ratio to the constricted diameter, are exactly proportional to the Golden Ratio 1.618 that is found throughout the natural world.

### BACKGROUND

Field of Invention; This invention measures the flow rate, temperature and pressure of a fluid traversing a conduit. The invention covers a technique for determining the flow rate based on unique geometry designed to amplify the pressure differential measured within the conduit.

Description of the Prior Art; Pitot tubes, orifice plates, nozzles, and venturis have been studied and used for many years to create measurable pressure drop in fluid metering devices. The literature is rich with calculations and theoretical derivations of flow equations based on physical dimensions and fluid properties for the meters described or studied. Pitot tubes have been widely used to measure point velocity and for determining flow in conduits with known flow profiles. Typically, the stagnation pressure point is put into the free-stream fluid flow in a conduit, not at a configured vena-contracta as used in this invention. And the static pressure port is exposed to the free stream velocity in the conduit also, not at a configured high-velocity location as used in this invention. Desliva (U.S. Pat. Nos. 9,746,389 and 10,539,444) recently claimed a conduit with a constriction straddled by upstream and downstream pressure sensors. Brower (U.S. Pat. No. 5,365,795) used a pitot-tube sensor configuration to create flow meters in venturis and orifices. Brower and others teach, “sensing a fluid total-pressure p.degree. at a first pressure sensing location in said conduit upstream of said flow constricting member” and “sensing a fluid static-pressure p.sub.3 at a second pressure sensing location downstream of an entrance of said flow constricting member;”. Other pitot-tube designs and applications use the tube to traverse a large conduit and obtain an average flow based on the flow profile. Some devices will have multiple sensing ports coupled to a sensor by a manifold to obtain an average flow value for the conduit. No prior art was found that teaches the methods outlined in this patent application.

### SUMMARY OF INVENTION

This device is used by fluidically coupling to a conduit wherein a fluid is flowing. The fluid thereby flows through the flow meter device and encounters an internal flow constricting member. By moving both sensing points downstream of the flow constriction in the conduit, this invention minimizes the effects of upstream flow disturbances on the first pressure sensing location. The diameter of the constriction location was designed to match the Golden Ratio of 1.618 of the conduit's full diameter. This design was found to be enough constriction to dissipate upstream disturbances and accelerate the fluid without causing excessive pressure drop in the fluid flow. The sloping profile of the flow-constricting member falls between an orifice and a venturi. This profile provides a fluid acceleration jet location known as a vena-contracta, where the venturi does not, and the fluid pressure drop due to the constricting member is much less than an orifice. The first sensing port P1, parallel and opposing the flow at the vena-contracta of the fluid stream is fluidically coupled to a pressure sensing device and measures an amplified stagnation-point pressure. The second sensing port P2 is fluidically coupled to a pressure sensing device and measures a diminished static-pressure at a configured high velocity point downstream of the first sensing port; thereby creating a magnified differential pressure signal at all flow rates, extending the operating range of the meter, and minimizing sensitivity to incoming flow disturbances or pipe elbow locations. Both sensor mV output signals are electrically coupled to the main microprocessor of the control/display unit; aka Digital Processing Unit. The differential pressure is correlated to fluid flow by a digital processing unit with access to tables stored in non-volatile memory.

In one embodiment the fluid specific gravity (SG) is manually entered into the microcontroller and the temperature of the fluid is measured by the controller from the signal of a NTC (Negative Temperature Coefficient) temperature sensor. The differential pressure reading from the two pressure sensors are proportional to the fluid flow rate. The meter is calibrated after assembly and the data table relating the differential pressure to flow is stored in the non-volatile memory of the controller. This invention creates a differential pressure signal that is unique for each flow rate. The conduit constriction creates a vena-contracta thereby increasing the fluid velocity, increasing the signal for lower flow rates beyond that possible with the prior art meters or traditional pitot-tube applications. The temperature is used with the SG to make fluid flow correction calculations within the microcontroller and display the corrected flow for the user.

In one embodiment, the microcontroller calculates the conduit static pressure based on the first sensor with a flow correction that was empirically determined. It then calculates and displays the Flow, Pressure, and Temperature on the first display screen. The second screen displays the five-minute average values for Flow, Pressure and Temperature. The third screen displays the calculated Total Flow for a duration determined by the user.

Calibration of the meter is done through a web-page portal using WIFI connectivity programmed into the microcontroller, or via the cloud-based dashboard location. A wire connection terminal strip is provided for flow signal output that is proportional to 4-20 mA, with two terminals for power supply input. Rotational memory data-logging onto an on board SD memory card records all the measured and calculated parameters from the meter with a date/time stamp on each data record.

### Description

### BRIEF DESCRIPTION OF THE DRAWINGS

FIG. 1 is the outside view of a typical embodiment of this flow meter with the power/data connector and controller attached

FIG. 2 is a centerline cutaway view of the internal components of the flow meter including both sensors and sensor ports, P1 and P2.

FIG. 3 is a centerline cutaway view of the internal components of the flow meter with a dynamic laminar flow element that balances the flow force with an enclosed spring damper mechanism.

### DETAILED DESCRIPTION OF THE DRAWINGS

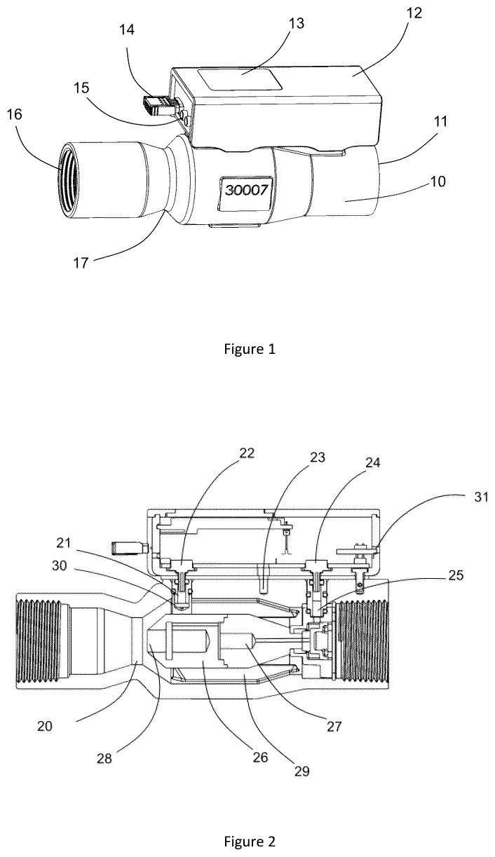

Referring to the depiction of the optimized pitot flow meter in FIG. 1, a conduit 10 made of resilient material for the fluid to flow within, may have a threaded inlet 16 location followed by an appropriate constriction of the conduit diameter 17. This constriction 17 mostly removes the effect of upstream flow disturbances before the flow reaches the sensor port locations. Constriction 17 also accelerates the fluid flow and directs it at an internal sensing port P1 to maximize the high-pressure signal delivered to the microcontroller within enclosure 12 mounted on top of the fluid conduit. Multiple screens and settings can be accessed within the microcontroller by using two buttons 15 provided and observing the display LCD 13 on top of the controller enclosure. Power supply, analog flow signal, and digital communication protocol signals are provided through connector 14 attached to controller enclosure 12.

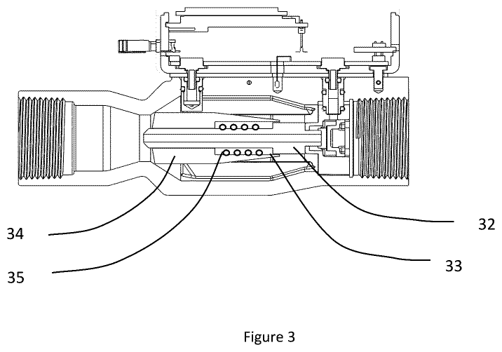

Referring to the depiction of the innards of the optimized pitot flow meter in FIG. 2, the ratio of the constriction diameter 20 divided by the conduit diameter 16 approximates the golden ratio of 0.618. The constriction is located by the golden ratio 0.618 times the overall length of the conduit. Pressure sensing devices 22 & 24 are mounted to the controller circuit board to allow x-y plane adjustment while fixed in the z-axis upward direction. This method allows the sensor to self-center on the sensing port for a good o-ring seal to the flow body 10 while resisting the internal pressure force in the z-axis direction. Exemplary o-ring seal locations are depicted at typical locations as fluid seals. P1 sensing point 25 is the total-fluid-pressure port sensing location. The pressure signal is communicated through the flow-element 26 and 27, then through a pressure snubber 25 before being received by the P1 sensor 24 and converted into a millivolt signal that is proportional to the pressure signal. The fluid conduit flow body 10 has internal guide vanes 29 to maintain the laminar-flow guide-element 26-27 in the center of the conduit while allowing flow to pass by the outer annulus. In a second embodiment FIG. 3 the laminar-flow guide-element 34 may be fixed or slide axially along the sensing shaft 32 to further magnify the pressure signals. When sliding axially the fluid pressure on element 34 is opposed by a spring 35. A fluid cavity 33 acts as an oscillation damper for element 34 by nature of a small annulus for fluid escape during flow pulsations in the conduit. A diminished static-pressure value is sensed by two opposing ports coupled to a passage perpendicular to the flow stream on the sides of a cylinder that accelerates the flow near the P2 sensing port location 21. This diminished static-pressure signal passes through a pressure snubber 30 before being received by the P2 sensor 22 and converted to a millivolt signal that is proportional to the pressure signal.

The threaded inlet 16 and outlet 11 ports may also be pipe flanges, or pipe unions.

The pressure sensors are electrically coupled to the microcontroller. Firmware within the microcontroller uses the millivolt signals from P1 and P2 sensors to calculate the differential pressure of these two points. That calculated differential pressure is used to extract the flow rate through the meter from a table of values stored within non-volatile memory of the controller during calibration. That flow rate is then corrected for fluid conditions based on the temperature sensor and fluid specific gravity to display the instantaneous flow rate on the LCD Display.

The five-minute average values are also calculated and displayed on a second screen 13 that is selectable using the buttons on the side of controller 15. A totalizing calculation is also performed and displayed on a third screen 13 for the user to record the total flow through the meter over a selected period that can be reset with the said buttons 15.

All of the calculated parameters are written to a .csv file if a SD memory card is inserted into the available slot 31 in the controller. The same values are transmitted via WIFI to a local pc or smart device web browser and to a cloud location for remote viewing and interface with the microcontroller.

I claim:

1. A flow meter device for ascertaining a flow rate and the static-pressure of fluid flowing within a conduit, said conduit having an overall flow area, said device comprising:
a flow constricting member and a laminar-flow guiding-element in said conduit, said flow constricting member defining a fluid passage having a preselected flow area and shape creating a vena-contracta downstream of the constricting member, and said laminar-flow guiding-element defining a fluid passage with preselected flow area to induce amplified fluid velocity;
an amplified total-fluid-pressure P1 at a first pressure sensing location in said conduit slightly downstream of said flow constricting member, fluidically coupled to a pressure sensing device;
a reduced fluid-pressure P2 at a second pressure sensing location further downstream of said flow constricting member than P1 and at the amplified velocity point of the laminar-flow guiding-element, fluidically coupled to a pressure sensing device;
a non-volatile memory configured to store tabular values relating sensor mV differential pressure (P1-P2) to the flow rate through the said conduit; and
a digital processing unit electronically coupled to said memory and electronically coupled to said pressure sensing devices positioned at said locations P1 and P2 being capable of determining said flow rate and said static-pressure based on detected values of said fluid pressure P1 and said fluid pressure P2, independent of a ratio of said flow area to said flow constricting member or said laminar-flow guiding-element to said overall conduit flow area.

2. The invention of claim 1 wherein the said laminar-flow guiding-element is not fixed and can move parallel to the flow stream based on fluid velocity while remaining centered by internal guide-vanes emanating from the inner walls of the fluid conduit, thereby extending the flow measurement range of the flow meter device.

3. The invention of claim 1 further comprising a temperature sensor for measurement of fluid temperature to calculate fluid density flow rate corrections within the said digital processing unit.

4. The invention of claim 2 further comprising a temperature sensor for measurement of fluid temperature to calculate fluid density flow rate corrections within the said digital processing unit.

5. A method of ascertaining a flow rate and static-pressure of fluid traversing a conduit, said conduit having an overall flow area, said method comprising the steps of:
passing said fluid through a flow constricting member and a laminar-flow guiding-element in said conduit passing said fluid through, said flow constricting member defining a fluid passage having a preselected flow area creating a vena-contracta downstream of the constricting element, and said laminar-flow guiding-element defining a fluid passage with preselected flow area to balance amplified velocity with fluid pressure drop;
sensing an amplified total-fluid-pressure P1 at a first pressure sensing location in said conduit slightly downstream of said flow constricting member;
sensing a reduced fluid-pressure P2 at a second pressure sensing location further downstream of said flow constricting member than P1 and at the maximum velocity point of the laminar-flow guiding-element;
determining said flow rate and said static-pressure based on detected values of said fluid pressure P1 and said fluid pressure P2 by (P1-P2) independent of a ratio of said flow area of said flow constricting member or said laminar-flow guiding-element to said overall conduit flow area;
referencing a non-volatile memory configured to store tabular values relating differential pressure (P1-P2) to flow rate through the said conduit;
utilizing a digital processing unit electrically coupled to said memory and electrically coupled to said pressure sensing devices positioned at said locations P1 and P2 being capable of determining said flow rate and said static-pressure based on detected values of said fluid pressure P1 and said fluid pressure P2, independent of a ratio of said flow area to said flow constricting member or said laminar-flow guiding-element to said overall conduit flow area; and
a method of determining said static-pressure based on the determined flow rate and P1 total-pressure value by accessing a look up table in the said non-volatile memory.

6. The method of claim 5 wherein the said laminar-flow guiding-element is not fixed, it can move parallel to the flow stream based on fluid velocity while remaining centered by the internal guide vanes, thereby extending the flow measurement range of the flow meter device.

7. The method of claim 5 further comprising measurement of fluid temperature for calculating density flow rate corrections within the said digital processing unit.

8. The method of claim 6 further comprising measurement of fluid temperature for calculating density flow rate corrections within the said digital processing unit.
